(19) United States
(12) Patent Application Publication
(10) Pub. No.: US 2007/0274762 A1
(43) Pub. Date: Nov. 29, 2007

(54) Nonabrasive bottle brush

(76) Inventors: Timothy L. Edwards, Holland, MI (US); Kim Marie Hayes, Rockford, MI (US); James Anthony Charameda, Holland, MI (US)

Correspondence Address: GREENBERG TRAURIG, LLP, 77 WEST WACKER DRIVE, SUITE 2500, CHICAGO, IL, 60601-1732, US

(21) Appl. No.: 11/439,612

(22) Filed: May 23, 2006

(51) Int. Cl. A46B 11/00; B43M 11/06; A47L 13/22

(52) U.S. Cl. 401/39; 401/183; 401/270

(57) ABSTRACT

A bottle brush comprising a handle connected to a bristle brush head composed of a single piece of molded thermoplastic material. The bristle brush head member comprises an integrated one-piece cylindrical core with a longitudinal axis from which a plurality of monolithically formed bristles extend radially outwardly. The handle includes an internal reservoir connected to a reservoir conduit tube channeling a cleaning fluid to the distal end of the brush head. The brush head further includes a reservoir plug with an internal recess containing a nipple brush. The nipple brush can be hinged to the end cap such that it can swivel from a first position inside the recess to second position in which it is exposed.

### BACKGROUND OF THE INVENTION

1. Field of the Invention

The present invention relates to brushes for baby bottles and other types of bottles, and in particular, to nonabrasive brushes that can gently clean polycarbonate and polypropylene bottles without scratching the bottles.

2. The Prior Art

A baby bottle is well known for generally supplying food and nourishment to an infant. Infants do not have as strong of an immune system as adults. Thus, it is essential to limit the growth of potentially harmful bacteria by properly sterilizing the bottle after each feeding. It is especially important to thoroughly remove the dregs formed within a bottle through a proper cleaning—in order to prevent the propagation of germs. Ideally, the bottles and nipples are thoroughly scrubbed and then sterilized by immersion in boiling water.

There are a large variety of brushes that can be used to clean baby bottles—most of them are comprised of a nylon bristle arrangement supported by a twisted wire structure attached to a handle. The problem with these prior art brushes is that the stiff nylon bristles can scratch and damage bottles made from certain polycarbonates. Polycarbonate bottles are preferred over other materials because they are less expensive to manufacture, shatter-resistant, and lightweight. However, polycarbonates are also more prone to scratching by nylon and other stiff bristled brushes. These scratches are not only unsightly, they can house and grow harmful bacteria in areas which are difficult to clean. More recently, concerns have arisen over the potential release of bisphenol-A from polycarbonate scratches.

The present invention is directed the to manufacture of a bottle brush having bristles composed of one or more low hardness or low durometer elastomers such as thermoplastic elastomers. In addition to being able to form bristles that don't scratch polycarbonate bottles, elastomers, also called elastoplastics, are materials which have elastomeric properties without requiring cure. They can be fabricated by rapid, economical methods usually employed in making thermoplastic articles. Because they are repeatedly reprocessable, scrap or defective articles can be recycled. Unlike an ordinary vulcanizable elastomer which does not develop elastomeric properties until it is cured, no curing step or long dwell time in a mold is necessary with the formation of thermoplastic elastomers. Also, more color variations are enabled with such thermoplastic elastomers.

U.S. Pat. No. 6,892,416, Lee et al., discloses a bottle brush that utilizes a silicon washing brush. However, Lee et al. directs its particular embodiments to a particular bottle shape and/or size. Thus, there is still a need for a nonabrasive bottle brush that can be used on almost any baby bottle shape and design. Lee et al. has the further disadvantage of requiring a complicated manufacturing process and requiring the bristles and outer surface of the core to be composed of different materials.

Additionally, while there are several patents, such as U.S. Pat. Nos. 2,726,417; 2,820,234; 4,229,116; 4,826,340; 6,210,064; 6,224,283; and 6,287,037, that disclose the use of internal reservoirs in a variety of brushes and several patents, such as, U.S. Pat. Nos. 5,339,480; 6,202,247; 6,349,443; and 7,017,222, that disclose the addition of an integrated nipple brush, there is still a need for a bottle brush that not only cleans polycarbonate bottles without scratching the bottles, but also combines an internal reservoir along with an integrated nipple brush, all in a single efficient cleaning utensil.

The present invention accordingly has, as an objective, the provision of a baby bottle brush in which the bristles are less likely to scratch the interior of a polycarbonate baby bottle. It is also an object of the present invention to provide for a bristle brush head arrangement in which the core and the bristles are composed of a single integrated material, for simultaneous molding, in order to eliminate the additional step of producing, adhering, welding, or otherwise securing the bristles to a separate distinct core structure and the costs associated it—while maximizing the degree of elastomeric deformation to the entirety of a bristle or brush head formed from the same non-scratching, yet readily deformable material. Likewise, the use of an integrated brush head facilitates its cleaning.

These and other objects of the inventions will become apparent upon review of the following claims, specification, and drawings.

### SUMMARY OF THE INVENTION

The present invention relates to a bottle brush for cleaning polycarbonate baby bottles. The bottle brush includes a handle and a bristle brush head member operably attached to the handle at one end. Preferably, the bristle brush head is a monolithically-formed, one-piece brush head member of simultaneously molded thermoplastic elastomer. The bristle brush head has a substantially cylindrical core with a longitudinal axis and a plurality of bristles extending radially from the cylindrical core.

In a preferred embodiment, the bristle brush head member further includes a plurality of distal end bristles protruding from the top of the bristle brush head member. The distal end bristles extend outwardly at an angle ranging between 0 and 90 degrees relative to the longitudinal axis of the cylindrical core.

Additionally, the handle can include an internal reservoir, a reservoir conduit tube, and a reservoir plug. The reservoir plug is removably attached to the internal reservoir such that removing the reservoir plug allows access to the internal reservoir connected to the reservoir tube, for filling with detergent. The bristle brush member encases the reservoir conduit tube at the distal end of the handle.

In a preferred embodiment, the brush head can be secured to the reservoir conduit tube by a collar having a first annular notch and a second annular notch. The notches secure the bristle brush head to the reservoir conduit tube by engaging each of a bristle brush member annular ring and a reservoir tube annular ring, respectively

In a preferred embodiment, the bottle brush is provided with a nipple brush oriented at the opposite end of the handle as the brush head member is located. The end cap can contain an internal recess to house the nipple brush. The nipple brush can also be hinged to the end cap such that it can swivel from a first position in which it is generally housed within the end cap, to a second position in which it is generally exposed.

In a preferred embodiment, the nipple brush is hinged to the end cap by a nipple brush swivel. The nipple brush swivel can have a swivel notch to facilitate manual deployment of the nipple brush.

Additionally, the nipple brush can be formed by nylon bristles connected to a twisted wire base. The twisted wire base can be made up of coated twisted wires.

In a preferred embodiment, the end of the nipple brush farthest from the hinge can bent approximately 180 degrees onto the remainder of the twisted wire base. A wire cap can cover the nipple brush distal end in order to prevent the twisted wire base from unraveling.

In a preferred embodiment, the reservoir plug is removably attached to the internal reservoir through the use of screw type threading.

In a preferred embodiment, the collar is maintained in position relative to the brush head member annular ring and reservoir tube annular ring by a sonic weld capable of affixing the two halves of the collar to one another and, in turn, to the handle.

Additionally, the reservoir and reservoir conduit tube can be each composed of a clear plastic material.

In yet another embodiment, the thermoplastic elastomer from which the bristles and cylindrical core are fabricated comprises a styrene-ethylene/butylene-styrene block copolymer.

The present invention also relates to a bottle brush with a handle and a bristle arrangement attached to the handle. The bristle arrangement has a plurality of bristles composed of a thermoplastic elastomer.

Further, the present invention also relates to a bottle brush with a handle and a bristle arrangement encasing a portion of the handle. The bristle arrangement is molded simultaneously of a single piece of material selected from one of a group of elastomeric materials. These materials include silicons, polyvinyl chlorides, thermoplastic elastomers, thermoplastic rubbers, and thermoplastic urethanes. The bristle arrangement includes a cylindrical core with a monolithically formed plurality of bristles extending radially outwardly from the cylindrical core.

### BRIEF DESCRIPTION OF THE DRAWINGS

FIG. 1 is a perspective view of the present invention.

FIG. 2 is an exploded view of the nonabrasive bottle brush of FIG. 1.

FIG. 3 is a cross sectional view of a nonabrasive bottle brush taken along lines 3-3 of FIG. 1, and looking in the direction of the arrows showing the bottle brush with the recess for the nipple brush.

FIG. 4 is an additional exploded view of a nonabrasive bottle brush.

FIG. 5 is an additional cross sectional view of a nonabrasive bottle brush taken along lines 3-3 of FIG. 1, and looking in the direction of the arrows showing the bottle brush with the recess for the nipple brush.

### DETAILED DESCRIPTION OF THE DRAWINGS

While this invention is susceptible of embodiment in many different forms, there are shown in the drawings and will be described in detail, several specific embodiments, with the understanding that the present disclosure is to be considered as an exemplification of the principles of the invention and is not intended to limit the invention to the embodiments illustrated.

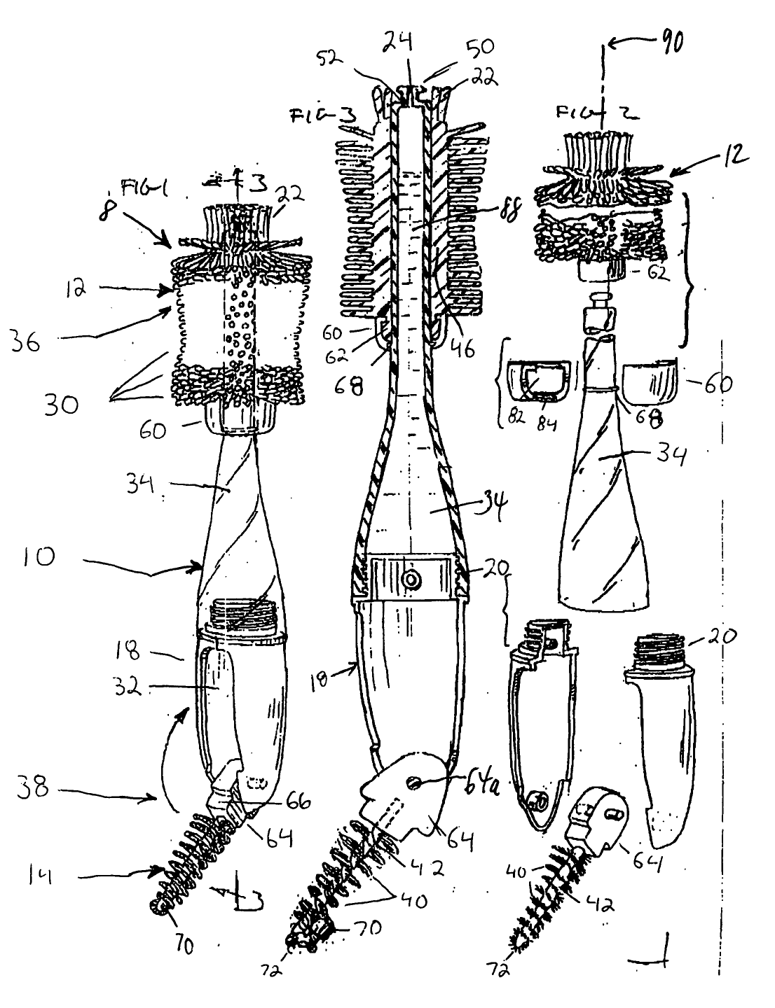

As shown in FIGS. 1 through 3, nonabrasive bottle brush 8, includes handle 10 with bristle brush head member 12 encasing distal end 36 of handle 10 and nipple brush 14 hinged at proximal end 38.

Bristle brush head member 12 is generally cylindrical in shape and preferably composed of a single piece of monolithically formed, molded thermoplastic elastomer. Thermoplastic elastomers have the advantage of being able to be processed by thermoplastic techniques (unlike elastomers), yet still yield a material with elastomeric properties when cooled. Some of the commercially available thermoplastic materials include segmented polyester thermoplastic elastomers, segmented polyurethane thermoplastic elastomers, segmented polyamide thermoplastic elastomers, blends of thermoplastic elastomers and thermoplastic polymers, and ionic thermoplastic elastomers. While several of these, and yet others, can be used as the material for the integrated present invention, a preferred thermoplastic elastomer is a styrene-ethylene/butylene-styrene block copolymer such as the SINOFLEX™ brand TPRP344-62 SEBS and the KRATON™ brand Polymers SEBS G Series. A preferred thermoplastic elastomer would have the following properties: a Shore OO of approximately 60 (generally equivalent to a Shore A reading of approximately 20), a specific gravity of 0.87, a tensile strength of 0.97 MPA, a break elongation greater than 800% (ASTM B-412), and a melt flow index of approximately 10.

Bristle brush member 12 is not limited to a thermoplastic elastomer material. Bristle brush member 12 can also be composed of a number of other low durometer or low hardness elastomers. These materials include but are not limited to silicons, polyvinyl chlorides, thermoplastic elastomers, thermoplastic rubbers, and thermoplastic urethanes.

Handle 10 includes reservoir plug 18, internal reservoir 34, and reservoir conduit tube 88. Reservoir plug 18 here comprising entire proximal end of the device, including recess 32 in which nipple brush 14 is contained.

Nipple brush 14, in one embodiment, is composed of nylon nipple brush bristles 40 attached to coated twisted wire base 42 and hinged to reservoir plug 18 at proximal end 36 such that it can swivel from a first position, in which nipple brush 14 is generally contained in recess 32, to a second position in which nipple brush 14 is generally exposed and extends outwardly from handle 10. Nipple brush 14 can be hinged to reservoir plug 18 through the use of nipple brush swivel 64. Nipple brush swivel 64 includes swivel notch 66. Swivel notch 66 aids a user in manually swiveling nipple brush 14 out when it is inside recess 32. Twisted wire base can also be capped with wire cap 70, preferably made of nylon or plastic. Wire cap 70 can help prevent twisted wire base 42 from unraveling.

FIGS. 3 and 5 are cross sectional views of one embodiment of the present invention, in which nipple brush 14 is exposed for use in FIG. 3 and retracted in FIG. 5. FIGS. 3 and 5 show cross sectional views of bottle brush 8 with recess 32. As shown in these figures, bristle brush head member 12 includes cylindrical core 46 with longitudinal axis 90 and a plurality of brush bristles 30 extending radially from the core. Bristle brush head 12 has also has a plurality of distal end bristles 22 protruding from the top of the bristle brush head 12. Distal end bristles 22 extend outwardly from bristle brush head 12 at an angle between 0 and 90 degrees from longitudinal axis 90. Distal end bristles 22 can aid in scrubbing the bottom of a baby bottle.

Internal reservoir 34 and reservoir conduit tube 88 are formed of a single unit. Internal reservoir 34 can contain a cleaning fluid which can be channeled by reservoir conduit tube 88 to tube opening 24 at distal end 36 of handle 10. Tube opening 24 allows the passage of a cleaning fluid to the surface being scrubbed by the bristles of the bottle brush. The reservoir conduit tube 88 also has a notch 52 located near distal end 36 to limit the flow of such fluids.

FIGS. 3 and 5 also show reservoir plug 18 removably attached to internal reservoir 34 such that removing reservoir plug 18 provides access to internal reservoir 34. Reservoir plug 34 is removably attached to internal reservoir 34 through the use of screw type threading 20.

As further shown by FIGS. 3 and 5, when encased by bristle brush head member 12, reservoir conduit tube 88 extends through cylindrical core 46 of bristle brush head 12 such that tube opening 24 extends to distal end bristles 22. Internal reservoir 34 and reservoir conduit tube 88 are aligned and preferably made of a substantially clear plastic material. This allows a user to observe the level and flow of the cleaning fluid while using the bottle brush.

Bristle brush head member 12 is secured to reservoir conduit tube 88 of handle 10 by cylindrical core 46 firmly encasing reservoir conduit tube 88.

FIG. 3 also details that the end of the nipple brush 14 located the farthest from hinge 64a can be bent approximately 180 degrees onto the remainder of the twisted wire base 42. This bending creates a plurality of end nipple brush bristles 72 that extend axially outward from twisted wire base 42. Nipple brush bristles 72 can aid in cleaning the interior tip of a nipple for a bottle.

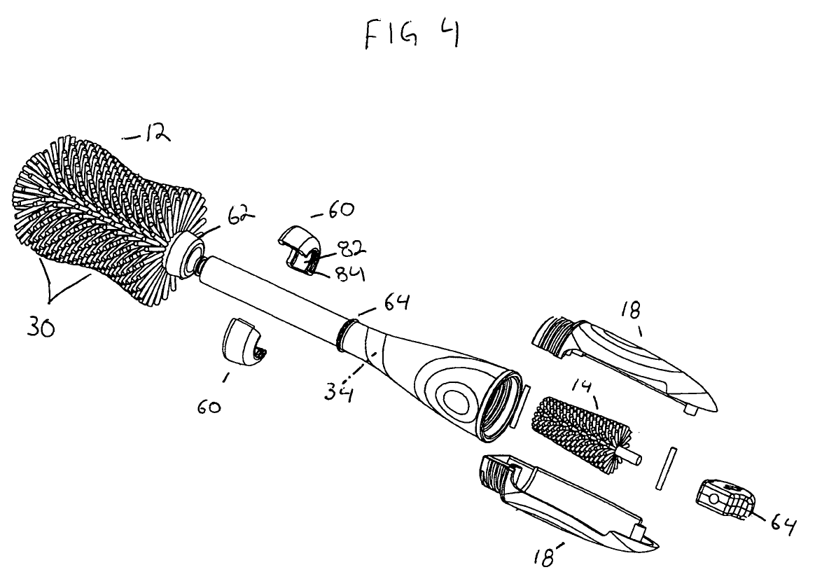

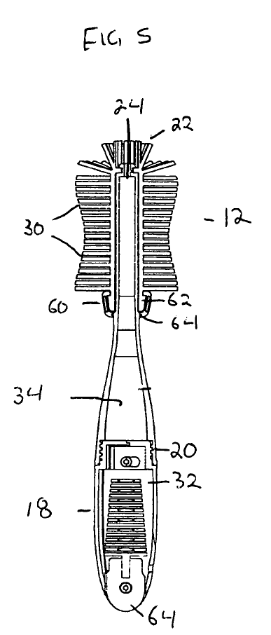

FIGS. 2 and 4 show exploded views of one embodiment of the present invention. As shown by these figures, bristle brush head 12 can be further secured to reservoir conduit tube 88 through the use of collar 60. The collar secures bristle brush head 12 to reservoir conduit tube 88 through a pair of annular notches, first annular notch 82 and second annular notch 84, each located on the interior surface of collar 60. First annular notch 82 engages bristle brush head annular ring 62, protruding from the bottom of cylindrical core 46 of the bristle brush head 12. Second annular notch 84 engages reservoir tube annular ring 68, emanating from handle 10. As shown best in FIG. 4, the collar is formed of two semicircular pieces that can be adhered or sonically welded together.

The exploded views of FIGS. 2 and 4 also show that the reservoir plug is preferably made of two molded plastic pieces connected together. The pieces can be connected together by adhesives, mechanical fasteners, or can be sonically welded together.

The foregoing description and drawings merely explain and illustrate the invention and the invention is not limited thereto, as those skilled in the art who have the disclosure before them will be able to make modifications and variations therein without departing from the scope of the invention.

What is claimed is:

1. A bottle brush for cleaning bottles, said bottle brush comprising:
a handle having a distal end and a proximal end opposite to said distal end; and
a bristle brush head operably attached to the handle at said distal end, the bristle brush head comprising a monolithically formed one-piece brush head member of molded thermoplastic elastomer including a substantially cylindrical core with a longitudinal axis and a plurality of brush bristles extending radially from said cylindrical core.

2. The bottle brush of claim 1 wherein the bristle brush head member further comprises a plurality of distal end bristles protruding from the top of the bristle brush head member, the distal end bristles extending at an angle ranging between 0 and 90 degrees relative to the longitudinal axis of said cylindrical core.

3. The bottle brush of claim 1 wherein the handle includes an internal reservoir, a reservoir conduit tube, and a reservoir plug, the reservoir plug being removably attached to the internal reservoir such that removing the reservoir plug allows access to the internal reservoir connected to the reservoir tube, the bristle brush head member encasing the reservoir conduit tube at the distal end of the handle, said reservoir tube terminating at the distal end of said handle, proximate to the distal end of said bristle brush head member.

4. The bottle brush of claim 1 wherein the bristle brush head is secured to the handle by a collar, the collar having a first annular notch and a second annular notch, said first annular notch and said second annular notch securing the bristle brush head to the handle by engaging a bristle brush head annular ring and a handle annular ring, respectively.

5. The bottle brush of claim 1 further comprising a nipple brush oriented at the proximal end of the handle.

6. The bottle brush of claim 5 wherein the end cap contains an internal recess used to house the nipple brush.

7. The bottle brush of claim 6 wherein the nipple brush is hinged to the end cap such that it can swivel from a first position in which it is generally housed within the end cap, to a second position in which it is generally exposed.

8. The bottle brush of claim 7 wherein the nipple brush is hinged to the end cap by a nipple brush swivel.

9. The bottle brush of claim 8 wherein the nipple brush swivel has a swivel notch used to facilitate manual deployment of the nipple brush.

10. The bottle brush of claim 7 wherein the nipple brush comprises nylon bristles connected to a twisted wire base.

11. The bottle brush of claim 10 wherein the twisted wire base is comprised of coated twisted wires.

12. The bottle brush of claim 11 wherein the nipple brush has a nipple brush distal end located at the end of the nipple brush farthest from a hinge point, the hinge point being the location where the nipple brush is hinged to the end cap, the nipple brush distal end being bent approximately 180 degrees onto the remainder of the twisted wire base.

13. The bottle brush of claim 12 further comprising a wire cap, the wire cap covering the nipple brush distal end in order to prevent the twisted wire base from unraveling.

14. The bottle brush of claim 2 wherein the reservoir plug is removably attached to the reservoir tube through the use of screw type threading.

15. The bottle brush of claim 4 wherein said collar is maintained in position relative to the brush head member annular ring and reservoir tube annular ring by a sonic weld.

16. The bottle brush of claim 4 wherein the reservoir and reservoir conduit tube are each composed of a substantially clear plastic material.

17. The bottle brush of claim 2 wherein the thermoplastic elastomer is a styrene-ethylene/butylene-styrene block copolymer

18. A bottle brush comprising:
a handle; and
a bristle arrangement attached to the handle, the bristle arrangement having a plurality of bristles, the bristles being composed of a thermoplastic elastomer.

19. A bottle brush comprising:
a handle; and
a bristle arrangement encasing a portion of the handle, the bristle arrangement molded of a monolithically formed, single piece of material, the material being one of a group of elastomeric materials including silicons, polyvinyl chlorides, thermoplastic elastomers, thermoplastic rubbers, and thermoplastic urethanes, the bristle arrangement including a cylindrical core, said bristle arrangement including a plurality of radial bristles extending radially outwardly from said cylindrical core.
